(19) United States
(12) Patent Application Publication
(10) Pub. No.: US 2008/0157477 A1
(43) Pub. Date: Jul. 3, 2008

(54) Mechanical Seal

(76) Inventors: Bruno Gaus, Offenburg (DE); Ingo Wiegand, Buehlertal (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/966,359

(22) Filed: Dec. 28, 2007

Related U.S. Application Data
(60) Provisional application No. 60/907,160, filed on Mar. 23, 2007.

(30) Foreign Application Priority Data
Dec. 29, 2006 (DE) 10 2006 062 523.4

(51) Int. Cl. F16J 15/16

(52) U.S. Cl. 277/320

(57) ABSTRACT

The invention relates to an apparatus for identifying a leak in a mechanical seal separating the side of a conveyor unit which is in contact with a medium from an electric drive which is arranged outside the medium. If there is a leak, the escaping medium is detected by a sensor element which is arranged in a hollow space, which is bounded by a removable component, and serves to identify escaping medium.

### CROSS REFERENCE TO RELATED APPLICATIONS

This application is based on German Patent Application No. 10 2006 062 523.4 filed 29 Dec. 2006, upon which priority is claimed, and on Provisional Application 60/907,160 filed on Mar. 23, 2007.

### BACKGROUND OF THE INVENTION

1. Field of the Invention

The invention relates to a mechanical seal, in particular between an electric drive and a fluid pump used, for example, in dishwashers.

2. Prior Art

DE 33 04 097 A1 relates to a single-action mechanical seal comprising a connection ring which is fixed to a rotating machine part and has a first annular sliding surface, and also a non-rotating sealing ring which is supported on a stationary machine part and has a second annular sliding surface which bears against the sliding surface of the stop ring during operation. The sliding surface of the sealing ring has at least one weakened section which is weaker than the rest of the sliding surface. The sealing ring contains a closed channel which is separated from the sliding surface by the abovementioned weakened section and is connected to a leak detector which reacts in response to the action of the liquid to be compressed.

DE 33 42 297 C2 relates to an apparatus for sealing off a bearing, which is lubricated with lubricant, of a drive shaft of ships or floating platforms or the like. The apparatus is equipped with a mechanical seal on the water side and with a pair of lip seals with sealing lips which face each other on the lubricant side. A leak space is made between the mechanical seal and the outer lip seal, and a lubricant chamber is formed between the lip seals. The leak space is connected via a leak line to an elevated leak liquid container which is provided with a ventilation pipe, and the lubricant chamber is connected by a lubricant line to an elevated lubricant container which is provided with a ventilation pipe. The elevated lubricant container is mounted above the elevated leak liquid container. The lubricant chamber contains at least one further lip seal, with a sealing lip which is directed toward the rear, between the rear lip seal and the issuing point of the lubricant line into the lubricant chamber. The lubricant supply apparatuses are connected to the lubricant line and increase the lubricant pressure in the lubricant line to approximately half the external water pressure at the water depth at which the drive device is normally located, when the pressure in the leak space rises above the normal value.

DE 197 24 308 A1 and EP 0 886 088 B1 relate to a diagnostic system for a mechanical seal, and disclose a method for determining the likelihood of failure and/or the theoretical residual service life of a mechanical seal, in which method the pressure of the medium, the leakage pressure, the moisture on that side of the mechanical seal which is averted from the medium, and also the temperature of the medium and/or the temperature of elements of the mechanical seal are measured. The measured values are compared with known comparison values, and the likelihood of failure and/or the remaining residual service life of the components are/is calculated from the deviation between the measured values and the known comparison values.

The apparatuses or methods known from the cited prior art permit only a rough estimation of the likelihood of failure of mechanical seals. Mechanical seals which are used, for example, in dishwashers, in particular on the flange between an electric drive and a pump which circulates wash fluid, are parts which are subject to wear and on which great demands are placed during long term operation of such systems and machines. On account of the unavoidable wear during the operating time, exchange deadlines by which the mechanical seals should be replaced, even if they appear to still be intact, are set at regular cyclical intervals.

### SUMMARY OF THE INVENTION

The present invention is based on the object of providing a mechanical seal which firstly can be monitored in the long term and secondly is very easily accessible for seal replacement.

The solution proposed according to the invention is distinguished primarily by its simplicity. A conveyor unit which is, for example, arranged within a tank of a conveyor-type dishwasher is connected to an electric drive which is provided outside the tank, with the interposition of a flange. The usually annular flange is located on the outside of the tank in which the conveyor unit and the fluid which is circulated in the conveyor unit are contained. In accordance with the solution proposed according to the invention, an annular groove in which a sensor element is accommodated is provided on the end face of the flange, preferably on that face of the flange which faces a dome-like raised area. The sensor element is connected to the controller of the conveyor-type dishwasher via electrical contact lines.

An annular groove which is bounded by a wall which bounds a hollow space is preferably made on the end face of the flange connection. The hollow space which is bounded by the wall and the end face of the flange is bounded by a removable covering ring. The covering ring contains a mechanical seal which has a movable sliding ring which can rotate in relation to a stationary sliding ring.

The annular groove which is made in the end face of the flange between the conveyor unit and the electric drive accommodates at least one sensor element which has, for example, two sensor pins which are connected to a controller via an electrical line in each case. The at least one sensor element is admitted into the annular groove on the end face of the flange by means of an interlocking or force-fitting, preferably removable, fixing system.

If the mechanical seal by means of which the conveyor unit, which is, for example, arranged in the tank of a treatment zone of the conveyor-type dishwasher, is sealed off from the tank base and the electric drive springs a leak, as may occur after an operating time of several hundred hours, water from the inside of the tank in which the conveyor unit is located enters the hollow space within the flange by means of the mechanical seal along the casing surface of the drive shaft on which the mechanical seal is accommodated. During rotation of the drive shaft of the electric drive, the water which enters is thrown against the wall, which bounds the hollow space, of the flange on account of the action of centrifugal forces and runs into the wall along the base surface of the hollow space. The water entering the hollow space collects in the annular groove on the end face of the flange in which the at least one sensor element is immersed. The hollow space is closed by the removable covering ring which can be easily removed from the flange—after removal of the conveyor unit from the tank—, so that the hollow space in which the water collects if there is a leak in the mechanical seal is easily accessible. An indication that the mechanical seal has failed or that complete breakdown of this component is imminent can be released to the machine control system by the at least one sensor element which is admitted into the annular groove on the end face of the flange in the hollow space. Each flange of each tank of the conveyor-type dishwasher, which may have a plurality of treatment zones which are connected in series, is preferably provided with at least one such sensor element, so that it is possible to indicate in the machine control system or in a display which is connected to the machine control system which mechanical seal in which tank in which treatment zone has failed or is just about to break down completely.

The at least one sensor element which is mounted in the flange within the hollow space with a removable covering ring is preferably connected to the machine control system of the conveyor-type dishwasher. The part of the mechanical seal which has failed can be easily removed on account of the covering ring which can be removed from the flange between the conveyor unit and the electric drive, and be repaired outside the machine. The covering ring which can be removed from the flange also makes it possible to dry the base of the hollow space within the flange, in which the groove is in the form of, for example, an annular groove, and therefore to remove from the hollow space all the water which has entered said hollow space. The removable covering ring can then be mounted on the flange again. This provides significantly better accessibility to the annular groove and also the option of completely drying the hollow space in the end face of the flange.

A central maintenance service for a region or country can continuously monitor the dishwasher using the machine control system, for example by connection of the machine control system to the Internet, so that, if necessary, a service technician with replacement parts can arrive in good time, in order to keep repair- and replacement-related downtimes of the dishwasher to a minimum.

The connection lines which make electrical contact with the at least one sensor element in the annular groove of the flange are likewise insulated from the tank which contains the flange which seals off the inside of the tank, which contains the fluid to be circulated, from the outside. The solution proposed according to the invention can be used particularly in conveyor unit/electric drive configurations which are oriented in a vertically suspended manner in relation to the base surface of a tank of a treatment zone of the conveyor-type dishwasher.

### BRIEF DESCRIPTION OF THE DRAWINGS

The invention is described in greater detail below with reference to the drawing, in which:

FIG. 1 shows a lateral section illustration of the flange with the tank base, conveyor unit, flange and electric drive which drives the conveyor unit illustrated in section,

FIG. 2 a perspective section illustration of the unit comprising conveyor unit, flange and electric drive, accommodated on a dome-like raised area of the tank of a treatment zone of the dishwasher,

FIG. 3 shows an illustration of the mechanical seal in the region of the tank base, and

FIG. 4 shows a schematic illustration of a sensor element which can be inserted into the annular groove, and the connection of said sensor element to a controller with a display or a monitor.

### DESCRIPTION OF THE PREFERRED EMBODIMENTS

Embodiments of a conveyor dishwasher unit 10 which is driven by means of an electric drive 12 are described in the text which follows. The conveyor unit 10 is connected to the electric drive 12 by means of a flange 14. The combination comprising conveyor unit 10 and electric drive 12 may be used in cleaning systems, for example conveyor-type dishwashers, be they belt- or rack-conveyor dishwashers, in domestic dishwashers, in commercially useable batch dishwashers or single-chamber dishwashers, in cleaning and disinfection devices for hospitals, residential homes for the elderly, or the like.

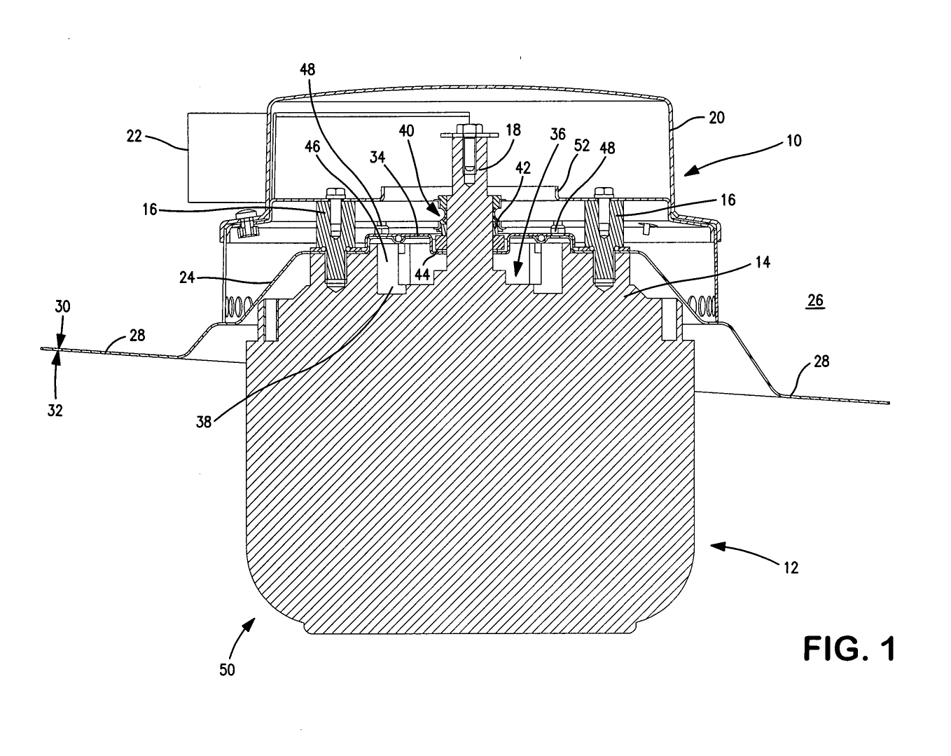

The illustration according to FIG. 1 shows that the conveyor unit 10 is connected to the electric drive 12 (which is schematically indicated here) by means of the flange 14. A plurality of stud bolts 16 which support a housing 20 of the conveyor unit 10 are located on the flange. An output shaft 18 by means of which the conveyor unit 10 (not illustrated in any detail) is driven extends from the electric drive 12. The conveyor unit 10 continuously or cyclically circulates a fluid, for example cleaning liquid or final-rinse liquid or the like, which is stored in a tank 26. The housing 20 of the conveyor unit 10 comprises an intake opening 22 through which the output shaft 18 of the electric drive 12 extends.

The illustration according to FIG. 1 shows that the electric drive and the conveyor unit 10 are arranged by means of the flange 14 in a vertically suspended arrangement 50 in relation to a tank base 28 of the tank 26. In order to accommodate the flange 14, the tank base 28 of the tank 26 has a dome-like, preferably truncated cone-like, raised area 24. The flange 14, whose stud bolts 16 extend through the tank base 28 of the tank 26, is mounted on the tank base 28 of the tank 26. The electric drive 12 is located on the outer face 32 of the dome-like, preferably truncated cone-like, raised area 24.

FIG. 1 shows a hollow space 46 formed in the flange 14. This hollow space 46 is bounded firstly by means of a removable covering ring 34 and secondly by means of the material of the flange 14 itself and finally by an end face 36 of the flange 14. A groove 38 is formed on the end face 36 of the flange 14 such that it runs concentrically in relation to the axis of the electric drive 12 or of the output shaft 18. The groove 38 is preferably designed as an annular groove and has a groove base. A mechanical seal 40 is located in the region of the removable covering ring 34. The mechanical seal 40 comprises a rotating ring 42 and a stationary ring 44.

The hollow space 46 is closed by means of the removable covering ring 34. The removable covering ring 34 can be fixed to the end face 36 of the flange 14 so as to close the hollow space 46, for example by means of fixing screws 48 or other fixing elements.

For the sake of completeness, reference is made to the fact that a pressure nozzle 22 is formed on the housing 20 of the conveyor unit 10 and the fluid which is to be circulated and is stored in the tank 26 is supplied to cleaning systems again by means of said pressure nozzle.

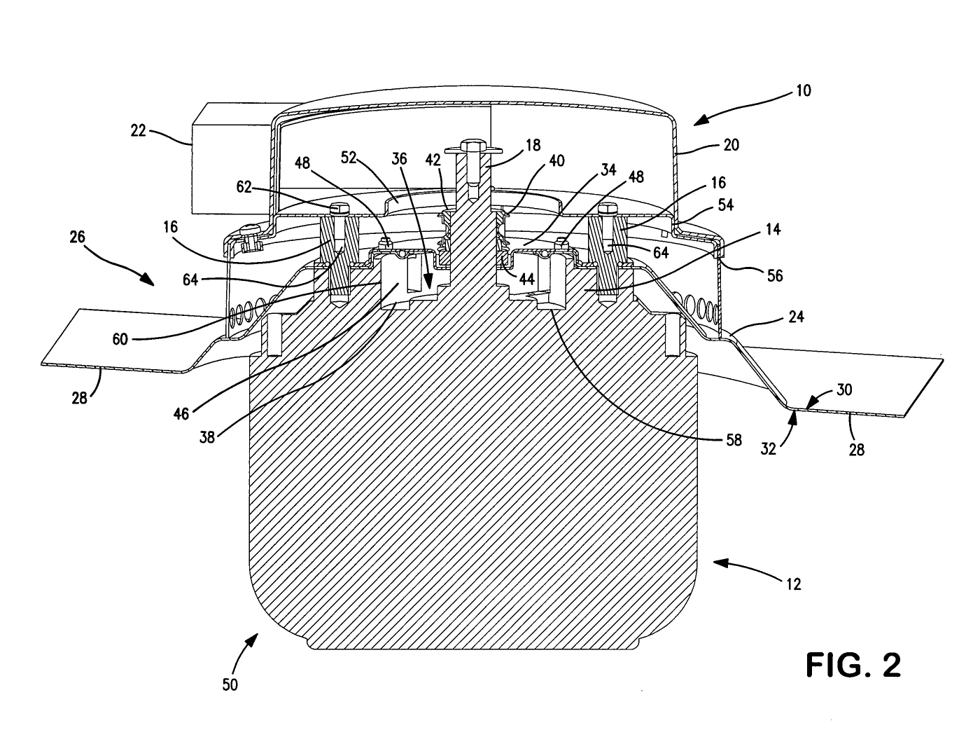

FIG. 2 shows a perspective arrangement of the unit comprising conveyor unit, flange and electric drive which is arranged on the outside in relation to the tank.

FIG. 2 shows that the dome-like, preferably truncated cone-like, raised area 24 is formed on the inner face 30 of the tank base 28 of the tank 26. The housing 20 of the conveyor unit 10 sits on said raised area.

FIG. 2 shows that the housing 20 of the conveyor unit 10 is accommodated in a ring system 54 on a centering dome 56 and is acted on by the fluid, which is to be circulated and is stored in the tank 26, by means of the pressure nozzle 22. The electric drive 12 is located on the outside 32 of the tank 26. The perspective view of the unit comprising conveyor unit, flange and electric drive which is illustrated in FIG. 2 shows that the groove 38 which is formed on the end face 36 of the flange 14 has a groove base 58. The hollow space 46 is closed firstly by the end face 36 of the flange 14, secondly by a wall 16 of the hollow space 46 and also by the removable covering ring 34. The hollow space 46 contains the mechanical seal 40 which comprises the rotating ring 42 and the ring 44 which is accommodated in the covering ring 34 in a stationary manner.

FIG. 2 also shows that the base of the housing 20 of the conveyor unit 10 is mounted on the stud bolts 16, which each have a blind hole 64, by means of screws 62. If fixing elements 62 in the form of screws are used, the blind holes 64 in the stud bolts 16 can be provided with internal threaded sections. The fluid which is to be circulated and is stored in the tank 26 flows to the conveyor unit 10 via an opening 52 which is formed in the base of the housing 20 of the conveyor unit 10. The fluid is circulated by this conveyor unit and leaves the housing 20 of the conveyor unit 10 by means of the pressure nozzle 22 and is conducted to a cleaning system (not illustrated) of a treatment zone of the conveyor-type dishwasher.

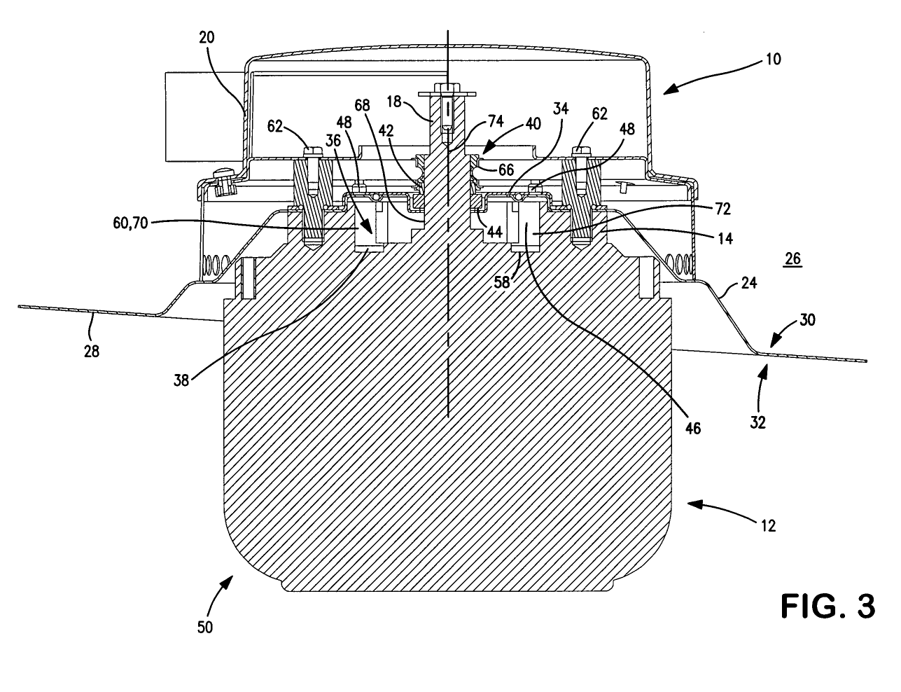

FIG. 3 shows an illustration of the mechanical seal which is formed on the flange between the electric drive and the conveyor unit. The hollow space 46 is bounded by the hollow space wall 60 which at the same time serves as a run-off surface 70 for splash water.

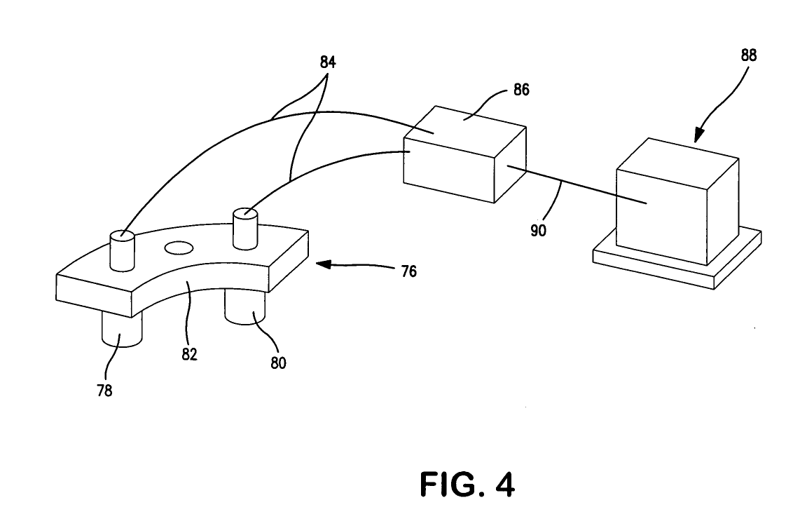

FIG. 3 also shows the mechanical seal 40 which comprises the rotating ring 42 and the stationary ring 44, between which a sealing gap is formed. The illustration according to FIG. 3 shows that the stationary ring 44 of the mechanical seal 40 is embedded in the stationary component covering ring 34 on account of the geometry of the covering ring 34. The rotating ring 42 which interacts with the stationary ring 44 is connected to the output shaft 18, which extends from the electric drive 12 through the flange 14 symmetrically to an axis 74, in a stationary manner by means of a sealing element 66 which is in the form of a sleeve or folding bellows. The illustration according to FIG. 3 further shows that the groove 38 runs in the end face 36 of the flange 14 and is bounded by the groove base 58. The flange 14 is preferably in the form of a rotary part into whose end face 36 the groove 38 can be milled. The illustration according to FIG. 3 shows that in this case the annular groove 38 is replenished with a reserve of water which has entered, in accordance with a water level 72. At least one sensor element 76 (compare FIG. 4), which is approximately in the form of an arc of a circle, is admitted into the groove 38 which is illustrated in FIG. 3 and is formed in the end face 36 of the flange 14.

If the mechanical seal 40 is defective or wear occurs during operation on account of the constant friction between the rotating ring 42 and the stationary ring 44, water from the housing 20 of the conveyor unit 10 continuously and constantly enters the hollow space 46, which is closed by the removable covering ring 34 which is in the form of a stationary component, along a casing surface 68 of the output shaft 18. On account of the rotation of the output shaft 18, the water splashes against the hollow space wall 60 which bounds the hollow space 46 in the radial direction and at the same time functions as a run-off surface 70 for the splash water. The water which flows downward in the vertical direction from the hollow space wall 60 collects in the groove 38 in the end face 36 of the flange 14. A rising water level 72 above the groove base 58 of the groove 38 can be detected by the sensor element 76 (compare the illustration according to FIG. 4) which is accommodated in the groove 38. On account of the solution proposed according to the invention, the ingress of water from the tank 26 into the hollow space 46 can be detected in the vertically suspended arrangement 50 of the conveyor unit 10 and the electric drive 12 in relation to the tank base surface 28, which arrangement is illustrated in FIG. 3 and moreover also in FIGS. 1 and 2.

FIG. 4 schematically shows the at least one sensor element which is inserted into the groove which is formed, for example, on an end face of a flange.

The sensor element 76 can be substantially in the form of an arc of a circle, for example as a 90° arc of a circle 82. A first sensor pin 78 and a second sensor pin 80 extend through this arc of a circle 82. The lengths by means of which the two sensor pins 78 and 80 protrude beyond the lower face of the arc of a circle 82 can be selected in accordance with the depth of the groove 38, that is to say the distance between the lower face of the arc of a circle 82 and the groove base 58, and are preferably designed such that the at least one sensor pin 78, 80 protrudes beyond the lower face of the arc of a circle 82 but does not stand on the groove base 58 but instead ends at a distance in front of it.

FIG. 4 shows that contact is made with each of the two sensor pins 78 and 80 via connection lines 84. The connection lines 84 which make contact with the ends of the sensor pins 78 and 80 on the upper face of the arc of a circle 82 are connected to the controller 86 at the other end. The controller 86 is, in turn, connected to a monitor, a display, a PC or the like via a data line 90. Therefore, an indication or a warning or a replacement message can be output as soon as the water level 72 within the groove 38 exceeds a specific maximum level. The sensor element proposed according to the invention can detect both a continuous increase in the water level 82, that is to say a gradual breakdown of the mechanical seal 40, and also sudden failure of the mechanical seal in the event of water breaking into the hollow space 46. The two sensor pins 78 and 80 are short-circuited by means of the water which collects above the groove base 58 in the annular groove 38, and a corresponding signal is generated via the contact lines 84, the signal being registered in the controller 86. The corresponding signal can be, for example, displayed on a machine display of the conveyor-type dishwasher by means of the controller 86, so that the operator is immediately informed as to the treatment zones of the conveyor-type dishwasher in which the mechanical seal provided there has failed.

Failure of a mechanical seal 40 on account of a corresponding increase in the water level 72 on the base of the hollow space 46 can be detected by means of the at least one sensor element 76 and output to a monitor, a display or a PC via connection lines 84, controller 86 and data line 90, with the PC being situated, for example, in a service center. On account of this solution, a system can be installed by means of which a mechanical seal 40 which is in a state of total failure can be replaced ahead of schedule in a maintenance measure within the scope of preventative measures or secondly replacement of the defective mechanical seal 40 can be immediately initiated in an emergency.

The foregoing relates to preferred exemplary embodiments of the invention, it being understood that other variants and embodiments thereof are possible within the spirit and scope of the invention, the latter being defined by the appended claims.

1. An apparatus for identifying a leak in a mechanical seal which separates the wall of a conveyor unit which is in contact with a liquid medium from a electric drive mounted outside the medium, the apparatus comprising a rotatable shaft extending from the electric drive through an opening in the wall, a hollow space between the wall and the electric drive, the hollow space being bounded at the wall opening by a removable component, the shaft extending through the hollow space and the removable component, the mechanical seal being disposed between said shaft and said removable component for preventing the escape of liquid from the conveyor unit, and at least one sensor for sensing liquid which has escaped through the seal into the hollow space.

2. The apparatus as claimed in claim 1, further comprising a flange between said conveyor unit and said electric drive, said at least one sensor element protruding into a groove formed on an end face of said flange.

3. The apparatus as claimed in claim 1, wherein the at least one sensor element is in the form of an arc of a circle.

4. The apparatus as claimed in claim 1, wherein the at least one sensor element comprises a first and at least one further, second sensor pin.

5. The apparatus as claimed in claim 2, wherein said flange is employed to connect said conveyor unit and said electric drive to one another.

6. The apparatus as claimed in claim 1, wherein the conveyor unit is accommodated in the tank of a cleaning system, in particular a dishwasher, which is equipped with at least one treatment zone for items to be cleaned.

7. The apparatus as claimed in claim 6, wherein the tank comprises a base having a dome-like raised area formed therein and wherein the conveyor unit is fixed to the inner face of said raised area which faces the tank, and the electric drive is fixed to the outer face of said raised area.

8. The apparatus as claimed in claim 5, wherein said wall is the base of a tank, and wherein the conveyor unit and the electric drive are installed in a vertically suspended arrangement in relation to said tank base.

9. The apparatus as claimed in claim 1, wherein the stationary component is designed as a covering ring, and wherein the hollow space is freely accessable after removal of the stationary component.

10. The apparatus as claimed in claim 1, wherein said stationary component comprises an annular recess, and wherein said mechanical seal comprises a stationary component admitted into said recess in the stationary component.

11. The apparatus as claimed in claim 1, wherein a wall of the hollow space defines a boundary surface serving as a run-off surface for splash liquid.

12. The apparatus as claimed in claim 1, wherein the presence of liquid or the liquid level in the hollow space is monitored by means of the at least one sensor element.

13. The apparatus as claimed in claim 1, further compressing a controller, and connecting lines connecting at least one sensor element to the controller.

14. The apparatus as claimed in claim 13, further comprising a monitor and/or to a PC connected to said controller via a data line.

15. The apparatus as claimed in claim 1, wherein the at least one sensor element is adapted to be interrogated and/or addressed by means of a monitor, a display or a PC via Internet access.

16. The apparatus as claimed in claim 6, wherein the at least one sensor element is adapted to be interrogated and/or addressed by means of a monitor, a display or a PC via Internet access.

17. The apparatus as claimed in claim 7, wherein the at least one sensor element is adapted to be interrogated and/or addressed by means of a monitor, a display or a PC via Internet access.

18. The apparatus as claimed in claim 8, wherein the at least one sensor element is adapted to be interrogated and/or addressed by means of a monitor, a display or a PC via Internet access.

19. The apparatus as claimed in claim 9, wherein the at least one sensor element is adapted to be interrogated and/or addressed by means of a monitor, a display or a PC via Internet access.

20. The apparatus as claimed in claim 13, wherein the at least one sensor element is adapted to be interrogated and/or addressed by means of a monitor, a display or a PC via Internet access.
